(19) United States
(12) Patent Application Publication
(10) Pub. No.: US 2015/0133249 A1
(43) Pub. Date: May 14, 2015

(54) BICYCLE DRIVE CHAINWHEEL ASSEMBLY

(71) Applicant: TIEN HSIN INDUSTRIES CO., LTD., Taichung City (TW)

(72) Inventors: Vince Tsai, Taichung City (TW); Meng-Hua Chiang, Taichung City (TW)

(73) Assignee: TIEN HISN INDUSTRIES CO., LTD., Taichung City (TW)

(21) Appl. No.: 14/075,178

(22) Filed: Nov. 8, 2013

(51) Int. Cl. F16H 55/30

(52) U.S. Cl. CPC F16H 55/30
USPC 474/160

(57) ABSTRACT

A bicycle drive chainwheel assembly mounted on a ratchet seat annularly provided with a flange peripherally at one end is disclosed, which includes a sleeve, at least one first chainwheel, at least one second chainwheel, at least one first washer, and a stopper. The sleeve has a first end being provided with a retaining wall stopped by the flange at one end of the ratchet seat, and a second end being provided with a first engagement portion and a second engagement portion having different outer diameters; the first chainwheel and the second chainwheel are respectively sleeved on the first engagement portion and the second engagement portion, a first washer is disposed between the first chainwheel and the second chainwheel, and a stopper is disposed on the other end of the ratchet seat.

### BACKGROUND OF THE INVENTION

1. Field of the Invention

The present invention relates to a bicycle chainwheel assembly, and more particularly to a bicycle drive chainwheel assembly with a plurality of chainwheels and a plurality of washers combined on a sleeve.

2. Related Art

The conventional bicycle chainwheel assembly, as shown in FIG. 1, includes a plurality of sprocket disks 1 having different diameters and tooth numbers. The sprocket disks 1 have concave-convex inner ring teeth 2 which are engaged with the bicycle hub ratchet seat (not shown) so that the chainwheel assembly could drive the bicycle hub to rotate together. The conventional chainwheel assembly is formed by stacking a plurality of sprocket disks 1 having different diameters according to the size, so that the periphery of the chainwheel assembly has a step form so as to obtain different tooth number ratios to achieve the effect of changing the speed, but the conventional sprocket disks 1 require a plurality of pieces of sprocket disks 1 having different diameters to be fixed on the same hub ratchet seat, and the distance from the sprocket to the hub ratchet seat may increase as the teeth become larger. Therefore, a sprocket disk having a larger diameter has an excessively large area. As the sprocket disks 1 are directly engaged with the hub ratchet seat, when the sprocket disks 1 are subject to traction from the chain, when the distance from the sprockets to the hub ratchet seat is too large, a too large torque might occur to deform the sprocket disks 1.

In addition, the bicycle chainwheel assembly is a component for coupling the chain for rotational drive, whose sprockets continuously undergo the friction and pushing from the chain to cause wear. When it is necessary to change the sprocket disks 1, the sprocket disks 1 with a larger diameter require more materials for forging, and the portion from the sprockets to the inner ring teeth 2 causes an excessive waste of materials.

### SUMMARY OF THE INVENTION

In view of this, the main objective of the present invention is to solve the problem of excess weight of the chainwheel and a waste of the forging material in a conventional chainwheel assembly.

To achieve the above objective, the present invention discloses a bicycle drive chainwheel assembly mounted on a ratchet seat annularly provided with a flange peripherally at one end, and the “bicycle drive chainwheel assembly” according to the present invention comprises: a sleeve, at least one first chainwheel, at least one second chainwheel, at least one first washer, and a stopper. The sleeve has a first end and a second end, the first end is provided with a retaining wall stopped at the flange, and the second end is provided with a first engagement portion adjacent to the retaining wall and having an outer diameter smaller than that of the retaining wall and a second engagement portion having an outer diameter smaller than that of the first engagement portion. The first chainwheel is annularly provided with a plurality of first teeth peripherally, and the first chainwheel is provided with a first central hole sleeved on the first engagement portion. The second chainwheel is annularly provided with a plurality of second teeth peripherally, and the second chainwheel is provided with a second central hole sleeved on the second engagement portion. The first washer has a first aperture sleeved on the first engagement portion and is disposed between the first chainwheel and the second chainwheel, and the stopper is mounted on the other end of the ratchet seat.

Thus, the present invention at least has the following advantages:

1. The sleeve, the first chainwheel, the second chainwheel, the third chainwheel, the first washer, the second washer, the third washer, and the stopper in the present invention are all independent components, which is adaptive to industrial modular production and facilitates replacement of worn portions instead of the entire chainwheel. For example, when the first or second teeth are worn, the first or second chainwheel is replaced, and when the first or second engaging portions are worn, the sleeve is directly replaced.

2. The first chainwheel, the second chainwheel, the first washer, and the second washer in the present invention are all single components assembled on a sleeve, which reduces the volume required for the distance from the sleeve to the hub of the first chainwheel, the second chainwheel, and the like, and not only decreases the excess weight but also reduces an unnecessary waste of material during the forging. Moreover, as the torque generated by the chainwheel is shortened when the chainwheel is subject to the traction from the chain, the chance that the chainwheel is deformed can be reduced.

### BRIEF DESCRIPTION OF THE DRAWINGS

FIG. 1 is a schematic perspective view of a conventional bicycle chainwheel assembly;

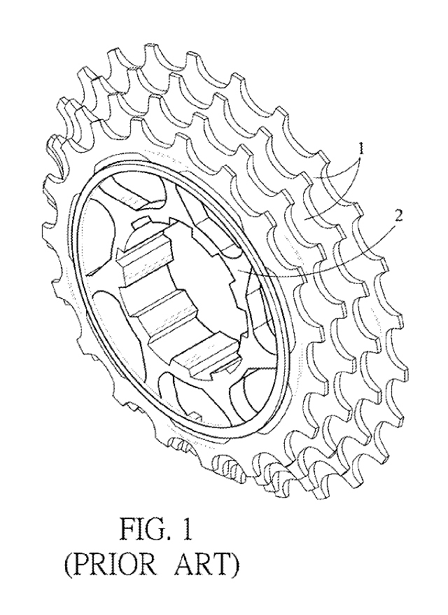

FIG. 2 is an exploded perspective view of an embodiment of the present invention;

FIG. 3 is a combined perspective view of the embodiment of the present invention; and

FIG. 4 is a combined sectional view of the embodiment of the present invention.

### DETAILED DESCRIPTION OF THE EMBODIMENTS

The detailed content and technology about the present invention are further described below with an embodiment.

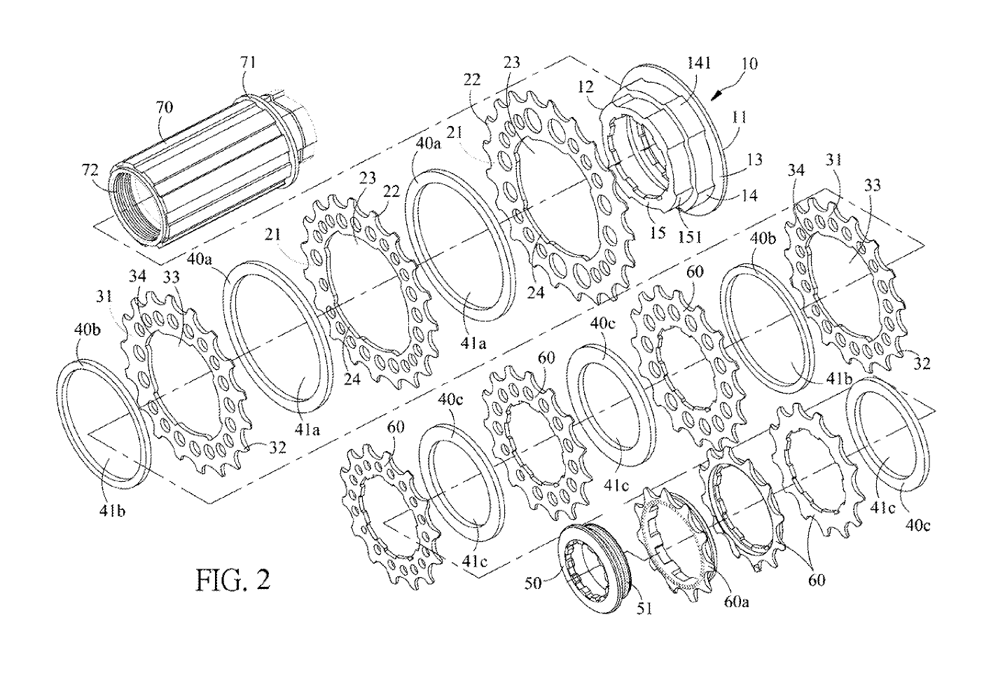

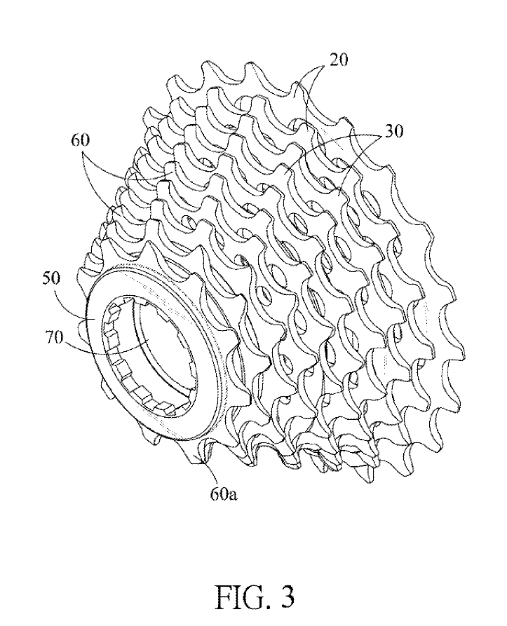

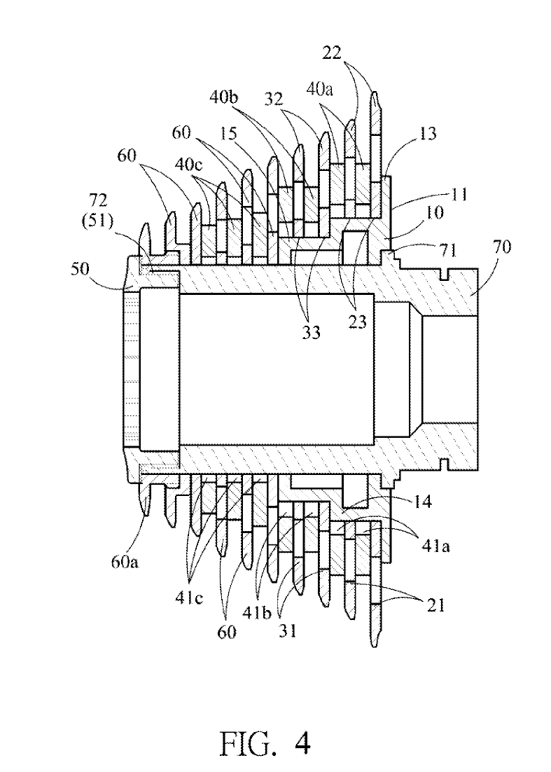

First, referring to FIGS. 2, 3, and 4, FIG. 2 is an exploded perspective view of an embodiment of the present invention, FIG. 3 is a combined perspective view of the embodiment of the present invention, and FIG. 4 is a combined sectional view of the embodiment of the present invention. Referring to FIG. 2 first, the present invention discloses a bicycle drive chainwheel assembly mounted on a bicycle ratchet seat 70 annularly provided with a flange 71 peripherally at one end and an inner screw 72 at the other end. The bicycle drive chainwheel assembly in the present invention includes a sleeve 10, at least one first chainwheel 21, at least one second chainwheel 31, at least one first washer 40a, at least one second washer 40b, and a stopper 50. The sleeve 10 is an annular hollow cylinder, directly sleeved on the ratchet seat 70 and stopped by the flange 71 at one end of the ratchet seat 70, the sleeve 10 has a first end 11 and a second end 12 on two opposite sides, the first end 11 is provided with an annular retaining wall 13, in which the retaining wall 13 will be stopped by the flange 71 when sleeved on the ratchet seat 70, and the second end 12 is provided with a first engagement portion 14 adjacent to the retaining wall 13 and having an outer diameter smaller than that of the retaining wall 13 and a second engagement portion 15 adjacent to the first engagement portion 14 and having an outer diameter smaller than that of the first engagement portion 14. The first engagement portion 14 is annular and has a plurality of first engaging portions 141 distributed peripherally, and the second engagement portion 15 is also annular and has a plurality of first engaging portions 151 distributed peripherally.

In this embodiment, the first engagement portion 14 is provided with two first chainwheels 21 having different tooth numbers and sizes, the first chainwheels 21 being opened at the center with a first central hole 23 for sleeving on the first engagement portion 14, and the first central hole 23 is provided with a first insertion slot 24 for being inserted by the first engaging portions 141 so that the first chainwheels 21 can be stably fixed onto the first engagement portion 14 and transfer the power driven by the bicycle chain to the ratchet seat 70. The largest first chainwheel 21 is mounted at a position adjacent to the retaining wall 13, and the smaller first chainwheel 21 is mounted at a position adjacent to the second engagement portion 15. The first chainwheels 21 are annularly provided with a plurality of first teeth 22 peripherally for engaging the bicycle chain for driving.

In addition, the second engagement portion 15 is provided with two second chainwheels 31 having different tooth numbers and sizes, the second chainwheels 31 being opened at the center with a second central hole 33 for sleeving on the second engagement portion 15, and the second central hole 33 is provided with a second insertion slot 34 for being inserted by the second engaging portions 151 so that the second chainwheels 31 can be stably fixed onto the second engagement portion 15 and transfer the power driven by the bicycle chain to the ratchet seat 70. The tooth numbers and sizes of the second chainwheels 31 are smaller than those of the first chainwheels 21, the largest second chainwheel 31 is mounted at a position adjacent to the first engagement portion 14 and is adjacent to the smallest first chainwheel 21, and the second chainwheels 31 are annularly provided with a plurality second teeth 32 peripherally for engaging of the bicycle chain for driving.

A first washer 40a is annular and is opened at the center with a first aperture 41a, and the first washer 40a is sleeved on the first engagement portion 14 of the sleeve 10 through the first aperture 41a and is disposed between two first chainwheels 21 as well as between the first chainwheels 21 and the second chainwheels 31. In this embodiment, the first engagement portion 14 is provided with two first chainwheels 21, the first washer 40a is disposed between two adjacent first chainwheels 21, and another first washer 40a is also disposed between the smallest first chainwheel 21 and the largest second chainwheel 31.

A second washer 40b is annular and is opened at the center with a second aperture 41b, and is sleeved on the second engagement portion 15 of the sleeve 10 through the second aperture 41b. In this embodiment, the second engagement portion 15 is provided with two second chainwheels 31, and a second washer 40b is disposed between two adjacent second chainwheels 31.

The stopper 50 is mounted at the other end of the ratchet seat 70, at least one third chainwheel 60 is disposed between the sleeve 10 and the stopper 50 which threads the ratchet seat 70, and a second washer 40b is disposed between the third chainwheel 60 and the second chainwheel 31. Referring to FIG. 4, in this embodiment, the stopper 50 is an annular threaded ring and has an external thread 51 formed peripherally for securing to an inner screw 72 of the ratchet seat 70, a plurality of third chainwheels 60 having different sizes is disposed between the sleeve 10 and the stopper 50, the third chainwheels 60 are annularly provided with a plurality of teeth, the tooth numbers and sizes of the third chainwheels 60 are smaller than those of the second chainwheels 31, and the third chainwheels 60 are arranged from the second engagement portion 15 to the stopper 50 in an order of descending sizes, so that the largest third chainwheels 60 are disposed adjacent to the second chainwheels 31, and the smallest third chainwheel 60a is adjacent to the stopper 50. A second washer 40b is disposed between the smallest second chainwheels 31 and the largest third chainwheels 60, a third washer 40c is disposed between two adjacent third chainwheels 60, and the third washer 40c is opened with a third aperture 41c sleeved on the ratchet seat 70. With the stopper 50 locked to the inner screw 72, the smallest third chainwheel 60a is pressed to connect the ratchet seat 70, and the sleeve 10, the first chainwheel 21, the second chainwheel 31, the first washer 40a, the second washer 40b, and the third washer 40c are installed together with the ratchet seat 70.

In addition, as the bicycle speed change system uses a plurality of front speed change chainwheels matching a plurality of rear speed change chainwheels to form different rotating gear ratios, the objectives of saving physical strength and increasing the speed are achieved according to the bicycle speed change system. Therefore, when the smaller chainwheel of the rear speed change chainwheel matches the larger chainwheel of the front speed change chainwheel, lateral torque will be generated while the bicycle chain drives the rear speed change chainwheel as lateral distances between the two chainwheels differ greatly. In this embodiment, during the riding, when the bicycle chain is engaged with the teeth on the third chainwheels 60, it may result in that the third chainwheels 60 are subject to the lateral torque in the process of traction from the chain and accelerate the wear on the teeth or even result in that the third chainwheels 60 are deformed and will stick the bicycle chain to cause a breakdown because the engagement of the bicycle chain and the third chainwheels 60 cannot be completely in a straight line. Thus, with the periphery of the third washer 40c extending to a position close to a groove between two teeth of the smaller third chainwheel 60, the larger third chainwheel 60 could obtain an extra lateral support force to counteract the lateral torque generated when the traction direction of the bicycle chain is unparallel to the rotation direction of the third chainwheel 60, thereby avoiding deformation of the third chainwheel 60.

Another benefit of present invention is that the first chainwheel 21, the second chainwheel 31, the first washer 40a, and the second washer 40b are all single components assembled on the sleeve 10. In use, if any component is worn or struck or even the sleeve 10 has been used for a considerable time and is worn, it can be replaced with a new one separately. Moreover, the third chainwheel 60, the third washer 40c, and the stopper 50 are also single components assembled on the ratchet seat 70 and also can be replaced at any time, which makes it convenient to detach and replace damaged chainwheels individually.

In view of the above, the bicycle drive chainwheel assembly according to the present invention can achieve the following advantages:

1. With the modular production, the sleeve, the first chainwheel, the second chainwheel, and the first washer are separate components, facilitating replacement for wear of each portion. For example, when the first or second teeth are worn, the first or second chainwheel is replaced, and when the first or second engaging portions are worn, the sleeve is replaced. Therefore, factories can produce a large number of individual parts in the manufacturing and save the excess production cost.

2. Consumers only need to replace damaged components to quickly repair the damaged system, which not only is convenient but also can be handled by common consumers without too much mechanical knowledge.

3. The sleeve serves as an additional support component; it can shorten the distance from the teeth of the first chainwheel and the second chainwheel to the driving force point, that is, the distance from the teeth to the engagement portion. The shortening of the distance can reduce the torque that the sprockets drive the chainwheels to rotate when subject to traction from the chain, thereby avoiding that the chainwheels are deformed due to excessive torque.

4. Installing washers having different sizes can provide a lateral support force for chainwheels having different sizes, so as to counteract the lateral torque generated when the tension direction of the chain is unparallel to the rotation direction of the chainwheel as the chain drives the chainwheel to rotate.

The present invention has been disclosed above with a preferred embodiment, but persons skilled in the art should understand that the embodiment is merely used to describe the present invention instead of limiting the scope of the present invention. It should be noted that any equivalent variation or replacement of the embodiment should fall within the scope of the present invention. Therefore, the protection scope of the present invention shall fall within the scope as defined by the claims below.

What is claimed is:

1. A bicycle drive chainwheel assembly mounted on a ratchet seat annularly provided with a flange peripherally at one end, the bicycle drive chainwheel assembly comprising:
a sleeve having a first end and a second end, the first end being provided with a retaining wall blocked at the flange and the second end being provided with a first engagement portion adjacent to the retaining wall and having an outer diameter smaller than that of the retaining wall and a second engagement portion having an outer diameter smaller than that of the first engagement portion;
at least one first chainwheel annularly provided with a plurality of first teeth peripherally, the first chainwheel being provided with a first central hole sleeved on the first engagement portion;
at least one second chainwheel annularly provided with a plurality of second teeth peripherally, the second chainwheel being provided with a second central hole sleeved on the second engagement portion;
at least one first washer having a first aperture sleeved on the first engagement portion and disposed between the first chainwheel and the second chainwheel; and
a stopper mounted on the other end of the ratchet seat to secure the bicycle drive chainwheel assembly onto the ratchet seat.

2. The bicycle drive chainwheel assembly as claimed in claim 1, wherein the first engagement portion is provided with at least two first chainwheels, and the first washer is disposed between two adjacent first chainwheels.

3. The bicycle drive chainwheel assembly as claimed in claim 1, wherein the second engagement portion is provided with at least two second chainwheels, a second washer is disposed between two adjacent second chainwheels, and the second washer has a second aperture for sleeving on the second engagement portion.

4. The bicycle drive chainwheel assembly as claimed in claim 1, wherein a plurality of first engaging portions is formed on the first engagement portion peripherally, and the first central hole is provided with at least one first insertion slot inserted by the first engaging portions.

5. The bicycle drive chainwheel assembly as claimed in claim 1, wherein a plurality of second engaging portions is formed on the second engagement portion peripherally, and the second central hole is provided with at least one second slot inserted by the second engaging portions.

6. The bicycle drive chainwheel assembly as claimed in claim 1, wherein at least one third chainwheel is disposed between the sleeve and the stopper for sleeving on the ratchet seat, and a second washer is disposed between the third chainwheel and the second chainwheel.

7. The bicycle drive chainwheel assembly as claimed in claim 6, wherein the teeth numbers and sizes of the third chainwheels are smaller than those of the second chainwheels, the smallest third chainwheel is adjacent to the stopper, a third washer is disposed between two adjacent third chainwheels, and the third washer is opened with a third aperture for sleeving on the ratchet seat.

8. The bicycle drive chainwheel assembly as claimed in claim 1, wherein the stopper is provided with an external thread for securing to an inner screw of the ratchet seat.
